(19) United States
(12) Patent Application Publication
(10) Pub. No.: US 2016/0086144 A1
(43) Pub. Date: Mar. 24, 2016

(54) PRINTING-FEE PAYMENT SYSTEM, NON-TRANSITORY COMPUTER READABLE MEDIUM, PRINTING-FEE PAYMENT METHOD, AND INFORMATION PROCESSING APPARATUS

(71) Applicant: FUJI XEROX CO., LTD., Tokyo (JP)

(72) Inventor: Masayoshi KISHIDA, Kanagawa (JP)

(73) Assignee: FUJI XEROX CO., LTD., Tokyo (JP)

(21) Appl. No.: 14/679,158

(22) Filed: Apr. 6, 2015

(30) Foreign Application Priority Data
Sep. 24, 2014 (JP) 2014-194024

(51) Int. Cl. G06Q 20/14; G06Q 20/24; G06Q 20/10

(52) U.S. Cl. CPC G06Q 20/145; G06Q 20/102; G06Q 20/24

(57) ABSTRACT

A printing-fee payment system includes a document receiving unit, a transmitting unit, a completion receiving unit, and a payment execution unit. The document receiving unit receives, from a user terminal, a document file and user information of a user who has commanded printing. The transmitting unit transmits, to a public printing system available for public use, print data of the document file and affiliation-site information for identifying an affiliation site with which the user is affiliated. The completion receiving unit receives a printing completion notification transmitted based on the affiliation-site information when the document file is printed using the public printing system. The payment execution unit executes a process for making the affiliation site pay a printing fee for the document file printed using the public printing system when the printing completion notification is received.

### CROSS-REFERENCE TO RELATED APPLICATIONS

This application is based on and claims priority under 35 USC 119 from Japanese Patent Application No. 2014-194024 filed Sep. 24, 2014.

### BACKGROUND

### Technical Field

The present invention relates to printing-fee payment systems, non-transitory computer readable media, printing-fee payment methods, and information processing apparatuses.

### SUMMARY

According to an aspect of the invention, there is provided a printing-fee payment system including a document receiving unit, a transmitting unit, a completion receiving unit, and a payment execution unit. The document receiving unit receives, from a user terminal, a document file and user information of a user who has commanded printing. The transmitting unit transmits, to a public printing system available for public use, print data of the document file and affiliation-site information for identifying an affiliation site with which the user is affiliated. The completion receiving unit receives a printing completion notification transmitted based on the affiliation-site information when the document file is printed using the public printing system. The payment execution unit executes a process for making the affiliation site pay a printing fee for the document file printed using the public printing system when the printing completion notification is received.

### BRIEF DESCRIPTION OF THE DRAWINGS

An exemplary embodiment of the present invention will be described in detail based on the following figures, wherein:

FIG. 1 illustrates the configuration of a printing-fee payment system according to an exemplary embodiment;

FIG. 2 illustrates a hardware configuration of a work-site print server;

FIG. 3 is a functional block diagram according to this exemplary embodiment;

FIG. 4 illustrates an example of data stored in a work-site print database;

FIG. 5 illustrates an example of data stored in a track-record database;

FIG. 6 illustrates an example of data stored in a public print database;

FIG. 7 is a flowchart illustrating a process executed in accordance with this exemplary embodiment; and

FIG. 8 is a flowchart illustrating the process executed in accordance with this exemplary embodiment.

### DETAILED DESCRIPTION

An exemplary embodiment of the present invention will be described below with reference to the drawings.

### 1. Exemplary Embodiment

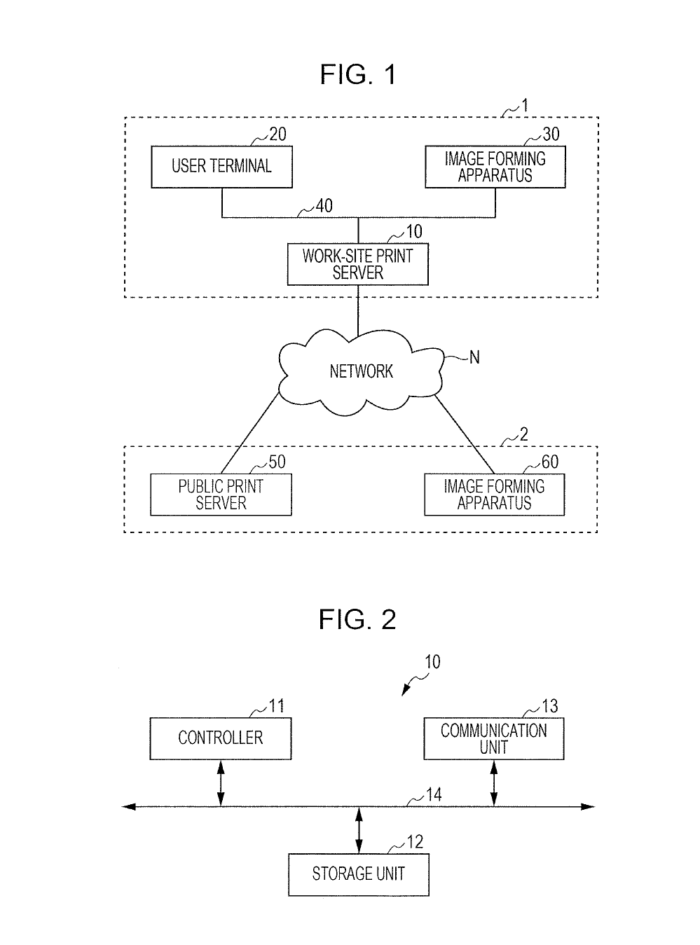

FIG. 1 illustrates the configuration of a printing-fee payment system according to an exemplary embodiment. As shown in FIG. 1, for example, a printing-fee payment system 1 includes a work-site print server 10 (computer), a user terminal 20, and an image forming apparatus 30. This exemplary embodiment relates to a case where the printing-fee payment system 1 is used in a firm with which multiple users are affiliated. The apparatuses in the printing-fee payment system 1 are connected in a data exchangeable manner via a local area network (LAN) 40 within a work site. Although each of the apparatuses in the printing-fee payment system 1 is described as being a single apparatus here, multiple apparatuses may be provided.

FIG. 2 illustrates a hardware configuration of the work-site print server 10. As shown in FIG. 2, the work-site print server 10 is a server computer as an information processing apparatus, and includes a controller 11, a storage unit 12, and a communication unit 13. These units are connected via a bus 14. The controller 11 includes, for example, a central processing unit (CPU) and executes a program stored in the storage unit 12 so as to control each unit of the work-site print server 10. The storage unit 12 includes, for example, various types of memory devices, such as a hard disk and a random access memory (RAM), and stores programs to be executed by the controller 11 as well as various kinds of data. The storage unit 12 is also used as a working memory. The communication unit 13 includes a network card and performs data communication with an external apparatus.

The user terminal 20 is a computer, such as a portable terminal or a personal computer, and includes a controller including a CPU, a storage unit including various types of memory devices, a communication unit including a network card, an operable unit including, for example, various kinds of buttons and a touchscreen, and a display unit including, for example, a liquid crystal panel. The user terminal 20 may also be regarded as a user-operable terminal in the printing-fee payment system 1. A user may operate the user terminal 20 so as to receive an electronic mail or to display various kinds of screens on a browser.

The image forming apparatus 30 is an image processing apparatus that includes one or multiple functions (such as a copying function and/or a printing function). In this exemplary embodiment, the image forming apparatus 30 is installed at the work site of the users. A work site is an example of an institution or an organization with which users are affiliated (i.e., an example of user affiliation site), which includes a corporation, such as a firm, or a public office. An institution or an organization with which users are affiliated may include a university or a non-profit organization. The image forming apparatus 30 prints a document file received by the work-site print server 10 from the user terminal 20. A document file is data to be printed and may be in any one of various types of data formats, such as an image format, a text format, or a rich text format. In this case, a user generates a business document file. The image forming apparatus 30 may include a controller, a storage unit, a communication unit, a display unit, and an operable unit similar to those in the user terminal 20.

As the storage units described above, various types of information storable media may be used, or semiconductor memory devices, for example, may be used. Furthermore, in this exemplary embodiment, the programs and the various kinds of data stored in the respective storage units may be acquired from an external apparatus via the corresponding communication units. Moreover, the hardware configuration of the work-site print server 10 and so on is not limited to the above-described example and may include various types of known hardware. For example, the work-site print server 10 may include a reading unit that reads programs and data stored in a computer-readable information storage medium.

The printing-fee payment system 1 is connected to a public printing system 2 in a data exchangeable manner via a network N. The public printing system 2 is available for public use. Specifically, a person not belonging to the work site of the users is also allowed to use the public printing system 2 to print a document file. On the other hand, in principle, the printing-fee payment system 1 only allows a person belonging to the work site of the users or a person given permission from the work site to print a document. In other words, the public printing system 2 is a system within a network (i.e., a network other than the LAN 40) different from that of the printing-fee payment system 1, and a body that manages the public printing system 2 (e.g., a system operating company) is different from that of the printing-fee payment system 1. The public printing system 2 includes a public print server 50 and an image forming apparatus 60, and these apparatuses are connected in a data exchangeable manner.

The public print server 50 is a server computer as an information processing apparatus, and includes a controller, a storage unit, and a communication unit. The hardware configuration of the public print server 50 may be identical to that of the work-site print server 10. The public print server 50 transmits print data received from the work-site print server 10 to the image forming apparatus 60 and makes the image forming apparatus 60 print the print data.

The image forming apparatus 60 is an image processing apparatus that includes one or multiple functions, such as a copying function and/or a printing function. The hardware configuration of the image forming apparatus 60 may be identical to that of the image forming apparatus 30. In this exemplary embodiment, the image forming apparatus 60 is installed in a retail store, such as a convenience store. The image forming apparatus 60 prints a document file based on the print data received from the public print server 50.

The printing-fee payment system 1 according to this exemplary embodiment is configured such that, when a user uploads a business document file to the work-site print server 10 by operating the user terminal 20 at the work site and then prints the business document file using the image forming apparatus 60 at, for example, a convenience store, the printing-fee payment system 1 makes the user's work site pay the printing fee. This configuration will be described in detail below.

### 2. Functions Implemented in Printing-Fee Payment System

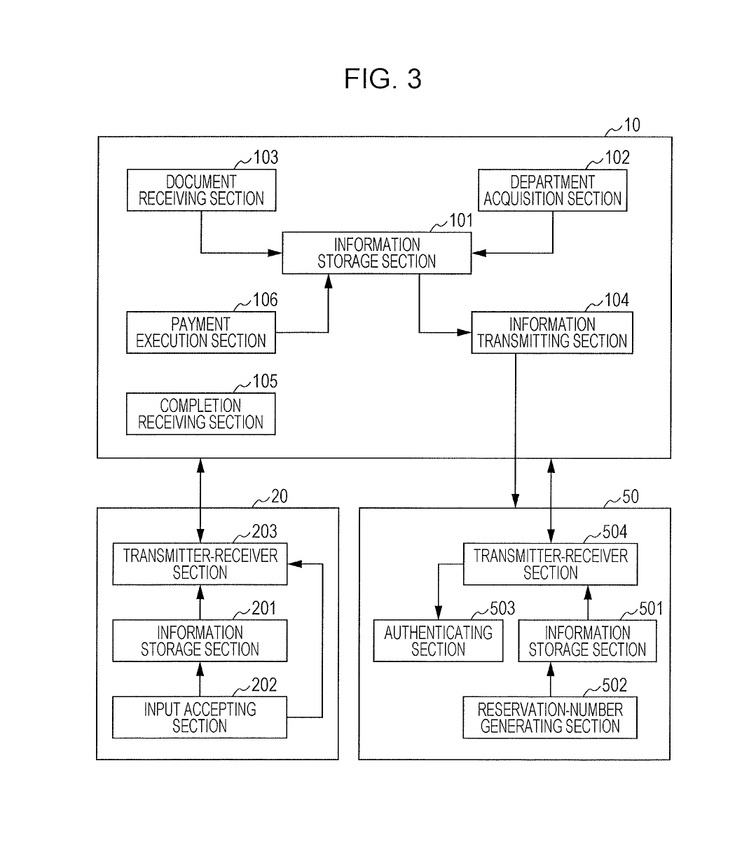

FIG. 3 is a functional block diagram according to this exemplary embodiment. The following description relates to functions implemented by the work-site print server 10, the user terminal 20, and the public print server 50.

2.1. Functions Implemented in Work-Site Print Server

The work-site print server 10 implements an information storage section 101, a department acquisition section 102, a document receiving section 103, an information transmitting section 104, a completion receiving section 105, and a payment execution section 106. The information storage section 101 is implemented by the storage unit 12. The department acquisition section 102, the document receiving section 103, the information transmitting section 104, and the completion receiving section 105 are implemented by the controller 11 and the communication unit 13. The payment execution section 106 is implemented by the controller 11.

2.1.1. Information Storage Section

The information storage section 101 stores various kinds of data related to printing of document files at the work site. In this case, a work-site print database and a track-record database will be described as examples of data stored in the information storage section 101.

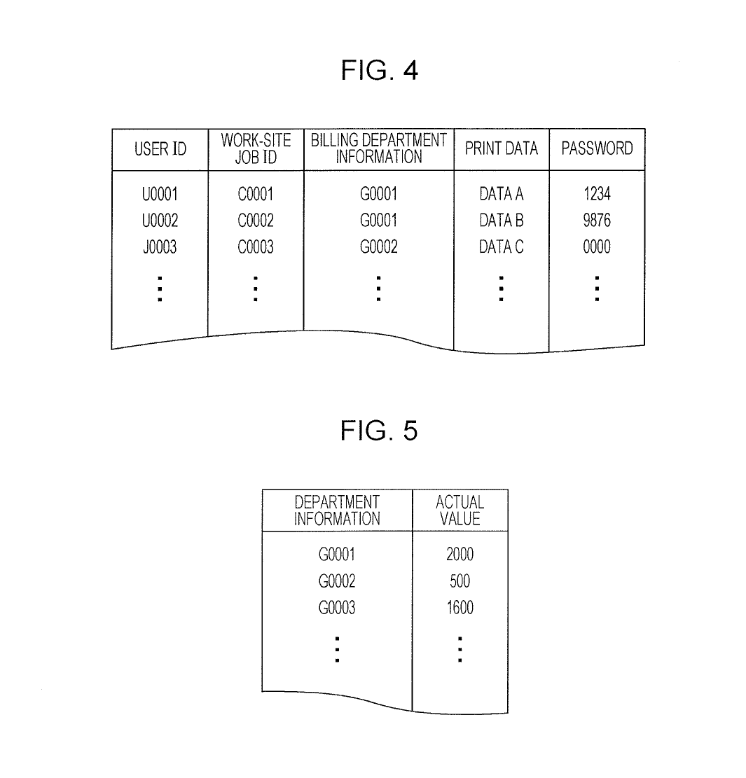

FIG. 4 illustrates an example of data stored in the work-site print database. As shown in FIG. 4, the work-site print database indicates print jobs registered in the work-site print server 10. For each print job, a user ID, a work-site job ID, billing department information, print data, and a password are stored in association with one another.

A user ID is information for uniquely identifying a user (i.e., information having a one-to-one relationship with a user) and is an example of user information. A work-site job ID is information for uniquely identifying a print job (i.e., information having a one-to-one relationship with a print job) registered in the work-site print server 10. Billing department information indicates a department that is to be billed for the printing fee of a document file printed using the public printing system 2. Print data is data obtained by processing a document file based on printing conditions designated by a user and is in a format printable using the image forming apparatus 30. A password is designated by a user and is authentication information for executing printing of a document file in the public printing system 2.

FIG. 5 illustrates an example of data stored in the track-record database. As shown in FIG. 5, the track-record database indicates actual values of printing fees billed to the work site. In this case, department information and an actual value are stored in association with each other. Department information indicates a department designated as a printing-fee billing destination. An actual value indicates a total amount of printing fees to be billed to a department. In this exemplary embodiment, a process for increasing an actual value corresponds to a process for paying a printing fee to the public printing system 2.

Data stored in the information storage section 101 is not limited to the above-described examples. For example, the information storage section 101 may store work-site information for identifying the work site of a user. For example, in a case where printing-fee payment systems 1 at multiple work sites use the public printing system 2, work-site information has a one-to-one relationship with each work site. Furthermore, for example, the information storage section 101 may store basic information of each user. Basic information includes a user ID, user's name, department information indicating a department with which the user is affiliated, and authentication information for user log-in. Moreover, the information storage section 101 may store print data to be printed using the image forming apparatus 30 at the work site.

2.1.2. Department Acquisition Section

The department acquisition section 102 acquires department information indicating user's department. In this case, the department acquisition section 102 acquires, from the user terminal 20, department information indicating a department input in the user terminal 20. Alternatively, the department acquisition section 102 may determine a user ID of a user who has logged into the printing-fee payment system 1 and acquire department information stored in the information storage section 101 in association with the user ID.

2.1.3. Document Receiving Section

The document receiving section 103 receives a document file from the user terminal 20. Furthermore, the document receiving section 103 receives, from the user terminal 20, a password for printing the document file using the public printing system 2. Moreover, in this exemplary embodiment, the document receiving section 103 receives print destination information indicating whether the document file is to be printed using the public printing system 2 or the printing-fee payment system 1 at the work site. The document receiving section 103 is configured to receive these pieces of information transmitted from a transmitter-receiver section of the user terminal 20.

2.1.4. Information Transmitting Section

The information transmitting section 104 transmits, to the public printing system 2 available for public use, print data of a document file and work-site information for identifying user's work site. The information transmitting section 104 is configured to transmit the print data stored in the work-site print database and the work-site information stored in the information storage section 101.

Furthermore, in this exemplary embodiment, the information transmitting section 104 transmits a password to the public printing system 2. The information transmitting section 104 is configured to transmit the password stored in the work-site print database. Moreover, if the print destination information indicates that printing is to be performed using the public printing system 2, the information transmitting section 104 transmits the print data and the work-site information to the public printing system 2. The information transmitting section 104 refers to the print destination information added to the document file received by the document receiving section 103 and determines whether printing is to be performed using the public printing system 2 or the printing-fee payment system 1.

2.1.5. Completion Receiving Section

In a case where a document file is printed using the public printing system 2, the completion receiving section 105 receives a printing completion notification transmitted based on the work-site information. The completion receiving section 105 is configured to receive a printing completion notification transmitted from a transmitter-receiver section 504 of the public print server 50. A printing completion notification may be data in a predetermined format indicating that printing has been completed. In this case, a printing completion notification includes a work-site job ID, a printing fee, and billing department information. In this exemplary embodiment, since a password is necessary for performing printing in the public printing system 2, the completion receiving section 105 receives a printing completion notification when a document file is printed in response to a password input in the public printing system 2.

2.1.6. Payment Execution Section

When a printing completion notification is received, the payment execution section 106 executes a process for making the work site pay the printing fee for the document file printed using the public printing system 2. In this exemplary embodiment, the payment execution section 106 executes a process for deducting the printing fee from the work-site's account. For example, the payment execution section 106 increases the actual value in the track-record database by an amount equivalent to the printing fee.

Furthermore, in this exemplary embodiment, the payment execution section 106 executes a process based on the billing department information. The payment execution section 106 executes a process for billing the department indicated by the billing department information for the printing fee. In this case, the payment execution section 106 refers to the track-record database and increases the actual value associated with the billing department information by an amount equivalent to the printing fee.

2.2. Functions Implemented in User Terminal

The user terminal 20 implements an information storage section 201, an input accepting section 202, and a transmitter-receiver section 203. The information storage section 201 is implemented by the storage unit of the user terminal 20. The input accepting section 202 is implemented by the controller and the operable unit of the user terminal 20. The transmitter-receiver section 203 is implemented by the controller and the communication unit of the user terminal 20.

The information storage section 201 stores a document file. The information storage section 201 may store a document file generated by a user or may store a document file received by the transmitter-receiver section 203 from an external computer.

The input accepting section 202 accepts designation of a document file stored in the information storage section 201 and also accepts designation of a password. Moreover, the input accepting section 202 accepts designation of whether the document file is to be printed using the printing-fee payment system 1 or the public printing system 2. Furthermore, the input accepting section 202 accepts designation of a department to be billed for a printing fee.

The transmitter-receiver section 203 transmits and receives various kinds of data. The transmitter-receiver section 203 transmits the document file designated by the user. Furthermore, the transmitter-receiver section 203 transmits the password accepted by the input accepting section 202. Moreover, the transmitter-receiver section 203 transmits the print destination information indicating the print destination system accepted by the input accepting section 202. Furthermore, the transmitter-receiver section 203 transmits the billing department information indicating the department designated by the user.

2.3. Functions Implemented in Public Print Server

The public print server 50 implements an information storage section 501, a reservation-number generating section 502, an authenticating section 503, and a transmitter-receiver section 504. The information storage section 501 is implemented by the storage unit of the public print server 50. The authenticating section 503 is implemented by the controller of the public print server 50. The transmitter-receiver section 504 is implemented by the controller and the communication unit of the image forming apparatus 30.

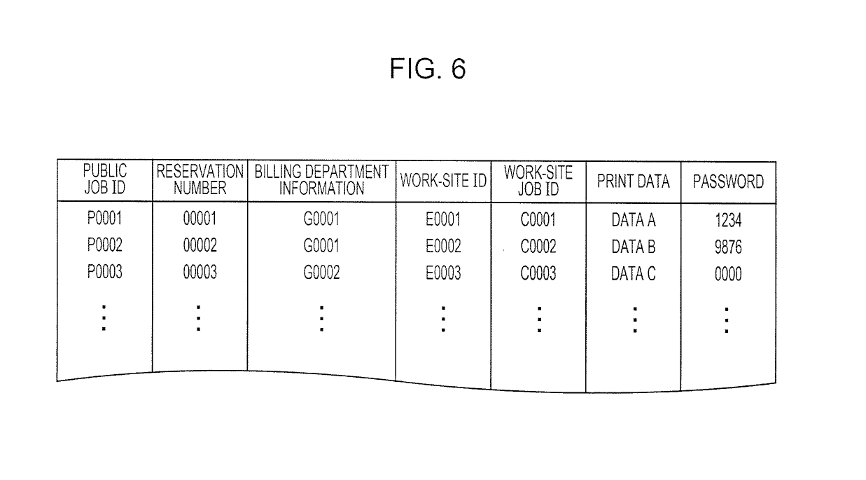

The information storage section 501 stores a public print database. FIG. 6 illustrates an example of data stored in the public print database. As shown in FIG. 6, the public print database indicates print jobs to be executed in the public printing system 2. For each print job, a public job ID, a reservation number, billing department information, a work-site ID, a work-site job ID, print data, and a password are stored in association with one another.

A public job ID is information for uniquely identifying a print job registered in the public print server 50 (i.e., information having a one-to-one relationship with a print job). A reservation number is information for identifying each print job and may be regarded as information to be used by a user for printing a document file. In other words, a reservation number may be regarded as information to be used by a user for designating desired print data among multiple items of print data stored in the public print database.

Data stored in the information storage section 501 is not limited to the above-described examples. For example, the information storage section 501 may store data indicating the association between a work-site ID and a printing-fee payment system 1 (e.g., a server name and an Internal Protocol (IP) address). Based on this association, it is possible to determine which printing completion notification of print data should be transmitted to which printing-fee payment system 1.

The reservation-number generating section 502 generates a reservation number. The reservation-number generating section 502 generates a reservation number based on a predetermined number-generating method such that the generated reservation number is not a duplicate of those of other print data.

The authenticating section 503 checks the validity of a reservation number and a password. The authenticating section 503 compares a combination of a reservation number and a password received by the transmitter-receiver section 504 with a combination of a reservation number and a password stored in the public print database and determines whether or not these combinations match.

The transmitter-receiver section 504 transmits and receives various kinds of data. The transmitter-receiver section 504 transmits the reservation number generated by the reservation-number generating section 502 to the printing-fee payment system 1. Furthermore, the transmitter-receiver section 504 determines a printing-fee payment system 1 to which a printing completion notification is to be transmitted based on a work-site ID. Then, the transmitter-receiver section 504 transmits a printing completion notification to the determined printing-fee payment system 1. In other words, the transmitter-receiver section 504 determines a printing-fee payment system 1 to be billed for a printing fee based on a work-site ID.

### 3. Process Executed in Exemplary Embodiment

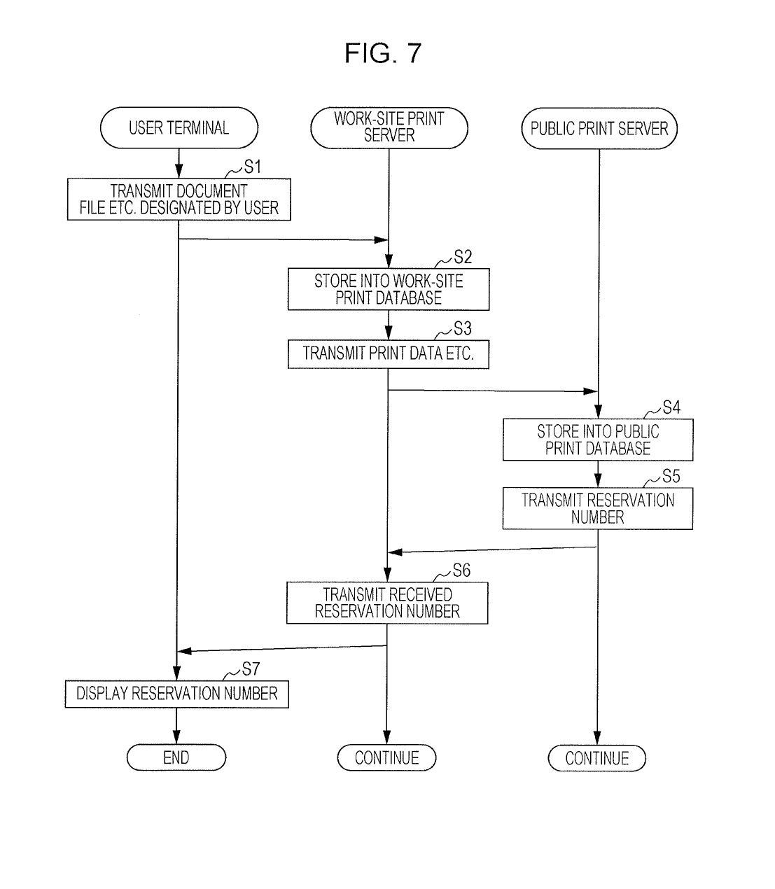

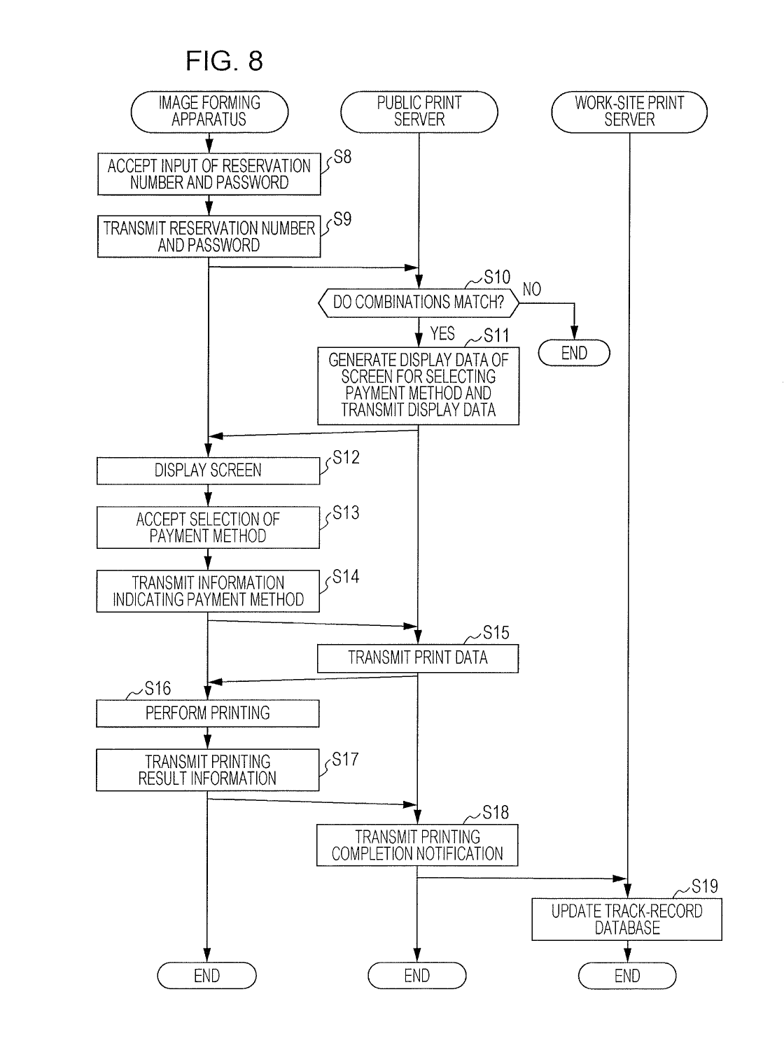

FIGS. 7 and 8 are flowcharts illustrating a process executed in accordance with this exemplary embodiment. The controller in each computer executes the process shown in FIGS. 7 and 8 in accordance with a program stored in the storage unit. By executing the process shown in FIGS. 7 and 8, the functions shown in FIG. 3 are implemented.

As shown in FIG. 7, in step S1, the user terminal 20 transmits, to the work-site print server 10, a document file designated by a user, user information of the user who has commanded printing, a password, billing department information, and print destination information. The display unit of the user terminal 20 displays a screen used for designating these pieces of information. The user operates the operable unit of the user terminal 20 so as to designate these pieces of information. In a case where the user information and the billing department information are managed by the work-site print server 10, the user may transmit the user information alone, and the work-site print server 10 may acquire the billing department information based on the received user information.

When the work-site print server 10 receives the transmitted contents in step S1, the work-site print server 10 generates a work-site job ID and print data and stores them into the work-site print database in step S2. Specifically, in step S2, the work-site print server 10 generates the work-site job ID such that the generated work-site job ID is not a duplicate of a work-site job ID already stored in the work-site print database. Then, the work-site print server 10 generates the print data based on the received document file. Subsequently, the work-site print server 10 stores the user ID, the work-site job ID, the billing department information, the print data, and the password into the work-site print database in association with one another. In this case, it is assumed that the user has logged into the printing-fee payment system 1 in advance, and that the work-site print server 10 is capable of determining the user ID. Furthermore, if the print destination information indicates that printing is to be performed using the image forming apparatus 30 at the work site, the document file is printed using the image forming apparatus 30 without executing a process from step S2 and onward. In step S3, the work-site print server 10 transmits the work-site job ID, the billing department information, the print data, and the password together with the work-site ID to the public print server 50.

When the public print server 50 receives the transmitted contents in step S3, the public print server 50 generates a public job ID and a reservation number and stores them into the public print database in step S4. Specifically, in step S4, the public print server 50 generates the public job ID such that the generated public job ID is not a duplicate of a public job ID already stored in the public print database. Furthermore, the public print server 50 generates the reservation number such that the generated reservation number is not a duplicate of a reservation number already stored in the public print database. Then, the public print server 50 stores the public job ID, the reservation number, the billing department information, the work-site ID, the work-site job ID, the print data, and the password into the public print database in association with one another. In step S5, the public print server 50 transmits the reservation number to the work-site print server 10.

In step S6, the work-site print server 10 transmits the received reservation number to the user terminal 20. In step S7, the user terminal 20 displays the received reservation number on the display unit. By executing the above process, the user becomes capable of printing the document file in the public printing system 2 by using the reservation number and the password. Subsequently, the user may go to a retail store, such as a convenience store, and operate the operable unit for printing the document file using the image forming apparatus 60.

Referring to FIG. 8, in step S8, the image forming apparatus 60 receives the reservation number and the password input via the operable unit. In step S9, the image forming apparatus 60 transmits the reservation number and the password input via the operable unit to the public print server 50.

In step S10, the public print server 50 determines whether or not the combination of the received reservation number and password matches the combination of the reservation number and the password stored in the public print database. In step S10, it may also be regarded that the public print server 50 authenticates whether or not the user is authorized to print the document file. If it is determined that the two combinations match (Yes in step S10), the public print server 50 generates display data of a screen for selecting a printing-fee payment method based on the billing department information associated with the reservation number and transmits the display data to the image forming apparatus 60 in step S11. This screen is used for selecting whether to bill the department indicated by the billing department information for the printing fee or to pay the printing fee by the user himself/herself. If the user selects to pay the printing fee, the user is made to pay the printing fee at the retail store by using a fee calculator equipped in the image forming apparatus 60. Alternatively, the billing department information may be not included in the screen used for selecting the printing-fee payment method transmitted from the public print server 50 to the image forming apparatus 60. In this case, the screen may display a message “bill department” alone. If multiple pieces of billing department information are transmitted from the work-site print server 10 to the public print server 50, a screen that displays these multiple pieces of billing department information may be generated on the screen for selecting the printing-fee payment method. In that case, the user may be made to select one of the multiple pieces of billing department information when printing is to be performed using the image forming apparatus 60.

When the image forming apparatus 60 receives the information transmitted in step S11, the image forming apparatus 60 displays the screen for selecting the printing-fee payment method on the display unit in step S12. In step S13, the image forming apparatus 60 accepts selection of the payment method by the user. In step S14, the image forming apparatus 60 transmits the information indicating the payment method selected by the user to the public print server 50. When the public print server 50 receives the information transmitted in step S14, the public print server 50 transmits the print data associated with the reservation number to the image forming apparatus 60 in step S15.

When the image forming apparatus 60 receives the print data, the image forming apparatus 60 prints the document file in step S16. In step S17, the image forming apparatus 60 transmits printing result information indicating a printing result to the public print server 50. The printing result information includes information indicating whether or not the printing has been successfully completed as well as information indicating the printing fee. Although the description here relates to a case where data indicating the printing fee is stored in the storage unit of the image forming apparatus 60, this data may alternatively be stored in the storage unit of the public print server 50. Any configuration is permissible so long as the data is stored in the public printing system 2 and the printing fee is determinable.

When the public print server 50 receives the printing result information transmitted in step S17, the public print server 50 transmits a printing completion notification to the work-site print server 10 in step S18. The printing completion notification transmitted in step S18 includes the work-site job ID and the billing department information associated with the print data for which the printing has been completed, as well as the information indicating the printing fee. If the user pays the printing fee at the retail store, the information indicating the printing fee and the billing department information are not included in the printing completion notification. Furthermore, by including the work-site job ID in the printing completion notification, the printing-fee payment system 1 is capable of determining which print job has been executed.

When the work-site print server 10 receives the printing completion notification, the work-site print server 10 updates the track-record database in step S19. In step S19, the work-site print server 10 refers to the public print database and increases the actual value associated with the billing department information included in the printing completion notification by an amount equivalent to the printing fee included in the printing completion notification.

The printing-fee payment system 1 described above makes the user's work site pay the printing fee for a document file printed using the public printing system 2. For example, it is troublesome for a user to temporarily pay the printing fee at, for example, a retail store and to charge the work site for the printing fee at a later date, and it is also unclear whether the actual document file printed by the user is for business. However, with the printing-fee payment system 1, the printing fee may be paid by the work site. In addition, with the work-site print database, document files printed using the public printing system 2 are manageable. Specifically, the user's work site may ascertain which document file has been printed in the public printing system 2 and whether the printing fee therefor has been billed thereto.

Furthermore, the printing-fee payment system 1 makes the user's department pay the printing fee. The printing-fee payment system 1 is capable of determining the department to be billed for the printing fee based on the billing department information. Moreover, the printing-fee payment system 1 deducts the printing fee from the work-site's account. By deducting the amount according to the actual value of each department stored in the track-record database from the work-site's account, the work site may be made to pay the printing fee.

Furthermore, a user may make the public printing system 2 print a document file by inputting a password. The user himself/herself may set the password to be used for performing printing in the public printing system 2. Furthermore, in a case where a document file is to be printed using the public printing system 2, the document file is printable using the public printing system 2. Therefore, the user may designate whether the document file is to be printed in the printing-fee payment system 1 or the document file is to be printed using the public printing system 2 by operating the user terminal 20 at the work site.

### 4. Modifications

The present invention is not limited to the above exemplary embodiment. Modifications are permissible so long as they do not depart from the scope of the present invention.

For example, as a first modification, if a user temporarily pays a printing fee at a retail store, a process in which the work site pays back that amount to the user may be performed. The payment execution section 106 in the first modification executes the process for paying back the amount of the printing fee to the user who has temporarily paid the printing fee. For example, the information storage section 101 stores a database in which a user ID and an actual value are associated with each other. In this case, the actual value is the total value of the printing fee temporarily paid by the user. The payment execution section 106 increases the actual value associated with the user ID by an amount equivalent to the printing fee. The actual value associated with the user ID is paid back to the user at a predetermined timing.

According to the first modification, the amount of the printing fee is paid to the user who has temporarily paid the printing fee. Therefore, even when the user prints a document file by paying the printing fee to, for example, a retail store in which the image forming apparatus 60 is installed, the amount of the printing fee temporarily paid by the user may be paid back to the user by the work site.

As a second modification, for example, the printing-fee payment process may be performed in accordance with a determination result indicating whether or not the printing result is a predetermined result. The completion receiving section 105 receives a printing completion notification including printing result information indicating a printing result of a document file printed using the public printing system 2. Specifically, in the second modification, the transmitter-receiver section 504 transmits, to the work-site print server 10, a printing completion notification including printing result information received from the image forming apparatus 60.

The payment execution section 106 executes a payment process based on a comparison result between the print data and the printing result information. For example, if it is determined that the printing has been successfully completed, the payment execution section 106 executes the payment process. If it is determined that the printing has not been successfully completed, the payment execution section 106 does not execute the payment process. In other words, if the printing result information indicates that printing desired by the user has not been completed, the payment execution section 106 does not execute a process for adding the printing fee to the actual value.

According to the second modification, the user's work site is made to pay the printing fee based on the comparison result between the print data and the printing result. Because the public printing system 2 is under the management of a body different from that of the work site, the printing-fee payment process is executed in view of the printing result so that a situation where the printing fee is undesirably paid even when the printing is not successfully completed may be prevented.

As a third modification, for example, the exemplary embodiment and multiple modifications may be combined.

Furthermore, for example, although the above description relates to a case where the printing-fee payment system 1 determines the department to be billed for the printing fee by receiving the billing department information from the public printing system 2, the printing-fee payment system 1 may receive the work-site job ID together with the printing completion notification and may determine the billing department based on the billing department information associated with the work-site job ID for which the printing has been completed.

Furthermore, for example, the process and the data format described above are examples, and various alterations are permissible so long as they do not depart from the spirit of the present invention. For example, each of the databases may store other information. Moreover, each of the functional blocks described above does not necessarily have to be implemented by the work-site print server 10 so long as the functional block is implemented by a computer included in the printing-fee payment system 1. Furthermore, the printing-fee payment system 1 may implement the document receiving section 103, the information transmitting section 104, the completion receiving section 105, and the payment execution section 106, and the remaining functions thereof may be omitted. Moreover, for example, the printing-fee payment system 1 may be implemented by a single computer.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A printing-fee payment system comprising:
a document receiving unit that receives, from a user terminal, a document file and user information of a user who has commanded printing;
a transmitting unit that transmits, to a public printing system available for public use, print data of the document file and affiliation-site information for identifying an affiliation site with which the user is affiliated;
a completion receiving unit that receives a printing completion notification transmitted based on the affiliation-site information when the document file is printed using the public printing system; and
a payment execution unit that executes a process for making the affiliation site pay a printing fee for the document file printed using the public printing system when the printing completion notification is received.

2. The printing-fee payment system according to claim 1, further comprising:
a unit that acquires department information indicating a department of the user,
wherein the payment execution unit executes the process based on the department information.

3. The printing-fee payment system according to claim 1,
wherein the payment execution unit executes the process for deducting the printing fee from an account of the affiliation site.

4. The printing-fee payment system according to claim 1,
wherein the payment execution unit executes the process for paying back the printing fee to the user who has temporarily paid the printing fee.

5. The printing-fee payment system according to claim 1,
wherein the document receiving unit receives, from the user terminal, a password for printing the document file using the public printing system,
wherein the transmitting unit transmits the password to the public printing system, and
wherein the completion receiving unit receives the printing completion notification when the document file is printed in response to the password input in the public printing system.

6. The printing-fee payment system according to claim 1,
wherein the document receiving unit receives information indicating whether the document file is to be printed using the public printing system or using a printing system of the affiliation site, and
wherein the transmitting unit transmits the print data and the affiliation-site information to the public printing system if the information indicates that the document file is to be printed using the public printing system.

7. The printing-fee payment system according to claim 1,
wherein the completion receiving unit receives the printing completion notification including printing result information indicating a printing result of the document file printed using the public printing system, and
wherein the payment execution unit executes the process based on a comparison result between the print data and the printing result information.

8. A non-transitory computer readable medium storing a program causing a computer to execute a printing-fee payment process, the printing-fee payment process comprising:
receiving, from a user terminal, a document file and user information of a user who has commanded printing;
transmitting, to a public printing system available for public use, print data of the document file and affiliation-site information for identifying an affiliation site with which the user is affiliated;
receiving a printing completion notification transmitted based on the affiliation-site information when the document file is printed using the public printing system; and
executing a process for making the affiliation site pay a printing fee for the document file printed using the public printing system when the printing completion notification is received.

9. A printing-fee payment method comprising:
receiving, from a user terminal, a document file and user information of a user who has commanded printing;
transmitting, to a public printing system available for public use, print data of the document file and affiliation-site information for identifying an affiliation site with which the user is affiliated;
receiving a printing completion notification transmitted based on the affiliation-site information when the document file is printed using the public printing system; and
executing a process for making the affiliation site pay a printing fee for the document file printed using the public printing system when the printing completion notification is received.

10. An information processing apparatus comprising:
a document receiving unit that receives, from a connected user terminal, a document file and user information of a user who has commanded printing;
a transmitting unit that transmits, to a public printing system available for public use, print data of the document file;
a completion receiving unit that receives a printing completion notification including a printing fee for the print data when the print data is printed using the public printing system; and
a payment execution unit that executes a process for making an affiliation site with which the user is affiliated pay the received printing fee.
